(19) United States
(12) Patent Application Publication
(10) Pub. No.: US 2015/0055345 A1
(43) Pub. Date: Feb. 26, 2015

(54) LIGHTING MODULE

(71) Applicant: KONINKLIJKE PHILIPS N.V., EINDHOVEN (NL)

(72) Inventor: Esra Ohl, Milan (IT)

(73) Assignee: Koninklijke Philips N.V.

(21) Appl. No.: 14/387,938

(22) PCT Filed: Mar. 25, 2013
(86) PCT No.: PCT/IB2013/052350

§ 371 Date: Sep. 25, 2014

(30) Foreign Application Priority Data
Mar. 26, 2012 (EP) 12161277.4

(51) Int. Cl. F21V 23/06; F21S 2/00

(52) U.S. Cl. CPC F21V 23/06; F21S 2/005; F21Y 2101/02
USPC 362/249.04

(57) ABSTRACT

The present application relates to a first lighting module (200) arranged to be mounted to a second lighting module (201). The first lighting module has a housing (204), a light source (206) and an electrical connector (218) electrically coupled to the light source. The housing (204) is configured to be coupled to a housing of a second lighting module (201) so that terminations (222) of the electrical connector of the first lighting module are brought into direct contact with terminations of an electrical connector of the second lighting module to establish an electrical connection between the first and second lighting modules. The present invention also relates to a system of lighting modules and an apparatus for connecting the terminations (132, 222) of a flexible circuit board (128, 218) to the terminations (140, 222) of another flexible circuit board or a printed circuit board (140, 218).

### FIELD OF THE INVENTION

The present invention relates to a first lighting module arranged to be mounted to a second lighting module. The present invention also relates to a system of lighting modules. Furthermore, the present invention also relates to an apparatus for connecting the terminations of a flexible circuit board to the terminations of another flexible circuit board or a printed circuit board. The present invention also relates to a first electrical apparatus arranged to be mounted to a second electrical apparatus.

### BACKGROUND OF THE INVENTION

It is known to connect discrete lighting modules to form a lighting system. Such lighting systems generally require the use of wires and/or connectors to electrically connect the lighting modules to each other. One such arrangement connects flexible circuit boards (FCBs), also known as flexible printed circuits (FPCs), to each other using a connector. An FCB generally comprises a flexible non-conductive substrate, such as a dielectric polymer film with a layer of conductive tracks disposed on one face of the substrate. The conductive tracks are formed of a metal or a conductive polymer with multiple tracks formed on the face of the substrate.

The conductive tracks have terminations which are arranged to be electrically connected to another FCB, a printed circuit board (PCB), or another electrical component. A connector unit may be used to electrically connect the terminations of an FCB to the terminations of another FCB, a PCB or another electrical component. Such an arrangement may have a male part mounted to the terminations of the FCB, for example metal sockets and/or pins on each single termination, and a female part mounted to the corresponding electrical component. The male part is received in the female part to electrically connect the FCB to the electrical component.

However, such an arrangement requires the step of providing connector parts on one or each of the FCB and/or the other component, and requires co-operating female and male parts. Therefore the connections are not interchangeable.

The connection of the terminations of an FCB to another FCB or a printed circuit board (PCB) may also be achieved by soldering or gluing. For example, the terminations of an FCB may be hot bar soldered onto a PCB, or glued by use of an anisotropic adhesive onto a PCB. However, such an arrangement is non-reversible and so it is not possible to separate the FCB from the other component to which it is mounted.

### SUMMARY OF THE INVENTION

It is an object of the invention to provide a first lighting module arranged to be mounted to a second lighting module and/or an apparatus for connecting the terminations of a flexible circuit board to the terminations of another flexible circuit board or a printed circuit board which substantially alleviates or overcomes the problems mentioned above.

According to the present invention, there is provided a first lighting module arranged to be mounted to a second lighting module, the first lighting module comprising a housing, a light source and an electrical connector electrically coupled to the light source, wherein the housing comprises a mounting unit which simultaneously is to at least partly accommodate and at least partly to be received by a corresponding mounting unit of a second lighting module to couple to said second lighting module so that terminations of the electrical connector of the first lighting module are brought into direct contact with terminations of an electrical connector of the second lighting module to establish an electrical connection between the first and second lighting modules.

The above arrangement enables the electrical connection between the first and second lighting modules to be simplified as a separate (electrical) connection component has become redundant and can be discarded of and hence, an advantage of the above arrangements is that the mounting unit is formed together with the housing. Furthermore the electrical connection of the first and second lighting modules at the same time occurs simultaneously with the coupling of the first lighting module housing to the second housing module housing and thus reduces the number of steps required to mount the first lighting module to the second lighting module. Additionally the mechanical connection between the first and second lighting module is relatively robust as the connection involves a mutual grip of both mounting units, i.e. a double grip. Moreover, the electrical connection is relatively reliable as the electric contacts are fully contained inside the housing and not exposed to the ambient and hence less likely to unintentionally touched by users and/or less liable to corrosion.

An embodiment of the first lighting module is characterized in that the mounting unit comprises an aperture bordered by three walls formed by a resilient flap, a protrusion oppositely arranged to the flap and a base surface of a base panel extending from the flap towards the protrusion. This construction renders the connection between the first and the second lighting module to be relatively robust as, due to a permanent resilient force by the flaps in a connected configuration, said first and second lighting module are permanently pressed onto each other. If the lighting module is further characterized in that the terminations are part of at least one of the three walls, the electrical connection between the first and the second lighting module is very robust and reliable, too. Furthermore, if the resilient flap comprises a free edge which is configured to engage, i.e. to snap, with an opposing ridge on the housing of the second lighting module, the reliability of the (electrical) connection is even further improved.

The electrical connector may be a first electrical connector and the first lighting module may further comprise a second electrical connector, the housing being configured to be coupled to a housing of a third lighting module so that terminations of the second electrical connector may be brought into direct contact with terminations of an electrical connector of the third lighting module to establish an electrical connection between the first and third lighting modules.

The above arrangement allows the first lighting module to be easily mounted to a plurality of other lighting modules.

The first lighting module may further comprise a circuit board disposed in the housing, wherein the first and second electrical connectors may be coupled to the circuit board and extend from the circuit board.

Therefore, the circuit board of one lighting module is simply connected to the circuit board of another lighting module.

The circuit board may be a printed circuit board.

The electrical connector may be received in the housing and the housing may be configured to locate the terminations of the electrical connector in direct contact with the terminations of the electrical connector of the second lighting module.

Therefore, the housing locates the terminations of the electrical connector in direct contact with the terminations of the electrical connector of the second lighting module without the need for any additional components or assembly steps.

The housing may be releasably attachable to the housing of the second lighting module so that the second lighting module is interchangeable with another lighting module.

Therefore, each lighting module is easily replaceable.

The mounting unit may be configured to bias the terminations of the electrical connector against the terminations of an electrical connector of the second lighting module.

Therefore, the compressive force between the terminations may be easily determined and controlled. Furthermore, tolerances in manufacture may be taken into account.

A surface of the mounting unit which is configured to locate against the electrical connector may be configured to be spaced from a surface of a mounting unit of the housing of the second lighting module by a distance equal to or less than the combined thickness of the electrical connectors of the first and second lighting modules when the housing is coupled to the housing of the second lighting module.

Therefore, the compressive force applied between the two circuit boards is easily determined.

The plane of the surface of the mounting unit may be configured to extend at an angle to the direction of attachment of the housing of the first lighting module to the housing of the second lighting module.

The above arrangement provides a wedged coupling, and so minimizes the effect of, for example, manufacturing tolerances. The arrangement also allows the surfaces of the mounting units to slide against each other to remove any detritus or oxidation to be removed from the surfaces as the terminations of the electrical connector of the first lighting module are brought into direct contact with terminations of an electrical connector of the second lighting module.

The first lighting module may further comprise a positioning element configured to position the electrical connector in the housing.

Therefore, the electrical connector is easily aligned in the correct position in the housing.

The electrical connector may be flexible.

The electrical connector may be a flexible circuit board.

According to another aspect of embodiments of the present invention, there is provided a system of lighting modules, wherein the housing of each lighting module is configured to be coupled to one or more of the other lighting modules so that the lighting modules are electrically connected to each other.

According to the present invention, there is provided a first electrical apparatus arranged to be mounted to a second electrical apparatus, the first electrical apparatus comprising a housing, an electrical component and an electrical connector electrically coupled to the electrical component, wherein the housing is configured to be coupled to a housing of a second electrical apparatus so that terminations of the electrical connector of the first electrical apparatus are brought into direct contact with terminations of an electrical connector of the second electrical apparatus to establish an electrical connection between the first and second electrical apparatus.

According to another aspect of embodiments of the present invention, there is provided an apparatus for connecting the terminations of a flexible circuit board to the terminations of another flexible circuit board or a printed circuit board comprising a first housing and a second housing, the first and second housings being configured to receive a first circuit board and a second circuit board there between, wherein the first and second housings are configured to locate the terminations of the first circuit board and the terminations of the second circuit board in direct contact with each other.

The above arrangement simplifies the electrical connection between the terminations of first and second circuit boards. The above arrangement removes the need to solder or glue the terminations of the circuit boards to each other, or to introduce a connector.

The first and second housings may be interchangeable.

Therefore, the first housing may be exchanged for another first housing and the second housing may be exchanged for another second housing. Furthermore, the first housing may be exchanged for a second housing and/or the second housing may be exchanged for a first housing.

The first housing and the second housing may be configured to be brought together to locate the terminations of the first circuit board and the terminations of the second circuit board in direct contact with each other.

Therefore, the first and second housings are able to enclose the circuit boards.

The first and second housings may be configured to act on at least one of the circuit boards to urge the terminations of the first and second circuit boards against each other.

Therefore, the terminations are simply urged into direct contact with each other.

The first housing may act on the first circuit board and the second housing may act on the second circuit board.

Therefore, assembly of the first and second housings ensures that the first and second housings are brought into direct contact with each other.

The first housing may comprise a mounting element which acts on the first circuit board to urge the terminations of the first circuit board against the terminations of the second circuit board.

The second housing may comprise another mounting element which acts on the second circuit board to urge the terminations of the second circuit board against the terminations of the first circuit board.

The mounting element and another mounting element may be the same.

At least one of the mounting elements may be a panel of one of the first and second housings.

The above arrangement provides that the first and second housings form at least on one of the mounting elements without the need to provide any further components. Therefore, manufacture of the apparatus is simplified.

At least one mounting element may be a protrusion formed in the panel.

The above arrangement allows for the distance between opposing mounting elements to be easily determined.

At least one mounting element may be a resilient element.

Therefore, the compressive force between the terminations may be easily determined and controlled. Furthermore, tolerances in manufacture may be taken into account.

At least one mounting element is fixedly mounted to the first or second housing.

This allows for ease of manufacture.

Each mounting element may have a mounting surface configured to locate against the corresponding first or second circuit board, the distance between the mounting surfaces being configured to be equal to or less than the combined thickness of a first and a second circuit board at their terminations.

Therefore, the compressive force applied between the two circuit boards is easily determined.

The plane of the mounting surface of each mounting element may be configured to extend at an angle to the direction of attachment of the first and second housings when the first and second housings are assembled.

The first housing may be configured to receive a first circuit board and the second housing may be configured to receive a second circuit board prior to assembly of the first and second housings.

With this arrangement the first circuit board can be mounted separately to the second circuit board prior to assembly of the first and second housings to each other. This also enables one of the housings to be easily exchanged for another identical housing.

The first housing may be configured to receive a first circuit board and a second circuit board prior to assembly of the first and second housings to each other.

With this arrangement the first and second circuit boards can be positioned in the first and second housings so that their terminations overlap each other prior to assembly of the first and second housings to each other.

The first and second housings may be configured to position the terminations of the first and second circuit boards so that the terminations face each other.

Therefore, the terminations are easily aligned.

The apparatus may further comprise a positioning element configured to position the circuit board.

The positioning element may be a rib, a threaded element, a latch or a peg. The positioning element may also be another form of geometrical protrusion.

The apparatus may further comprise at least two positioning elements which are configured to receive at least one circuit board there between.

The positioning element may be configured to extend through at least one circuit board.

The positioning element may be configured to fixedly engage the first housing to the second housing.

Therefore, the housing is easily and simply assembled.

The first and second circuit boards may be flexible circuit boards.

The first circuit board may be a flexible circuit board and the second circuit board may be a printed circuit board.

These and other aspects of the invention will be apparent from and elucidated with reference to the embodiments described hereinafter.

### BRIEF DESCRIPTION OF THE DRAWINGS

Embodiments of the invention will now be described, by way of example only, with reference to the accompanying drawings, in which:

FIG. 1 shows an illustrative perspective view of a lower housing for receiving and mounting flexible circuit boards (FCBs) with two FCBs received therein;

FIG. 2 shows an illustrative cross-sectional view of a housing for receiving FCBs with two FCBs received therein;

FIG. 3 shows an illustrative plan view of the lower housing shown in FIG. 1 with one FCB received therein;

FIG. 4 shows an illustrative plan view of the lower housing shown in FIG. 1 with two FCBs received therein;

FIG. 5 shows an illustrative exploded perspective view of a lighting module of a system of lighting modules;

FIG. 6 shows a plan view of a plurality of lighting modules shown in FIG. 5 coupled to each other to form a system of lighting modules;

FIG. 7 shows a partial perspective view of an arm of the lighting module of FIG. 5 prior to coupling of the arm to an arm of another lighting module;

FIG. 8 shows a partial cross-sectional side view of the arms of the lighting modules shown in FIG. 7;

FIG. 9 shows a partial cross-sectional side view of the arms of the lighting modules shown in FIG. 7 coupled to each other;

FIG. 10 shows an illustrative partial plan view of another lower housing with one FCB received therein;

FIG. 11 shows an illustrative partial plan view of another lower housing with one FCB received therein;

FIG. 12 shows an illustrative partial plan view of another lower housing with one FCB received therein;

FIG. 13 shows an illustrative partial plan view of another lower housing with one FCB received therein;

FIG. 14 shows an illustrative partial cross-sectional view of a housing arrangement with two FCB received therein;

FIG. 15 shows an illustrative partial cross-sectional view of another housing arrangement with two FCB received therein;

FIG. 16 shows an illustrative partial cross-sectional view of another housing arrangement with two FCB received therein;

FIG. 17 shows an illustrative partial cross-sectional view of another housing arrangement with two FCB received therein;

FIG. 18 shows an illustrative partial cross-sectional view of another housing arrangement with two FCB received therein; and

### DETAILED DESCRIPTION OF THE EMBODIMENTS

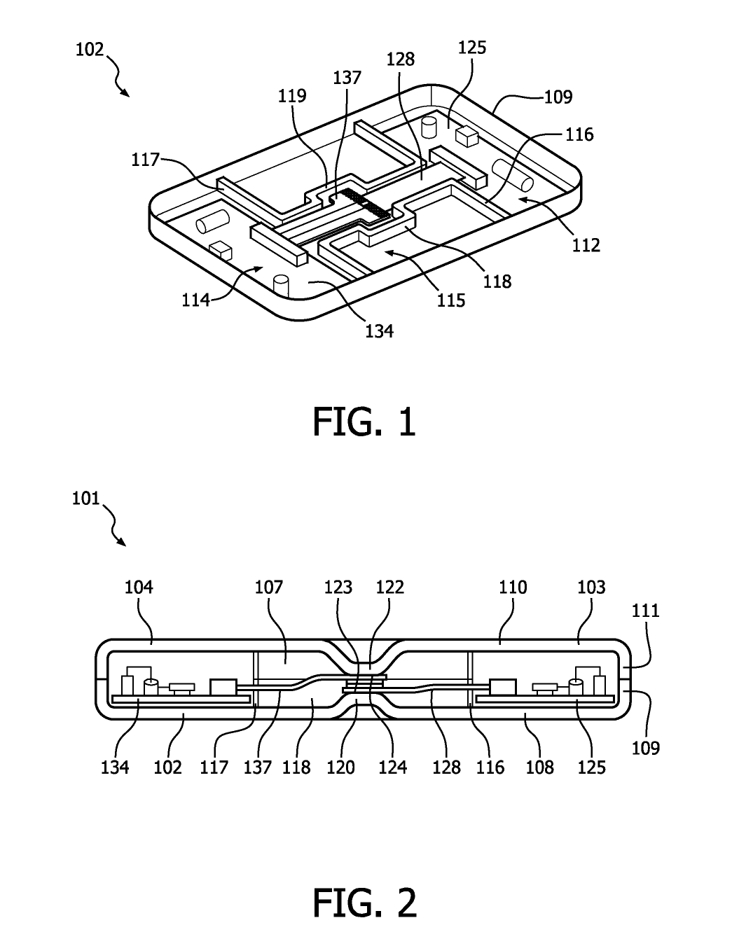

Referring to FIGS. 1 and 2, a system for connecting terminations of a flexible circuit board (FCB) against terminations of another flexible circuit board is shown. However, it will be understood that the system is also able to connect the terminations of an FCB to the terminations of a printed circuit board (PCB). Alternatively, the system may be used to connect the terminations of a PCB to another PCB. In FIG. 1 a lower housing 102 of an outer shell 101 is shown. In FIG. 2 an upper housing 103 is shown mounted to the lower housing 102. The lower housing 102 and the upper housing 103 together form the outer shell 101. The outer shell 101 is formed from a rigid material, for example a plastic, however it will be understood that alternative materials may be used. The upper housing 103 is releasably mountable to the lower housing 102. However, it will be understood that the housings may be mounted to each other to be non-releasable.

A cavity 107 defining a circuit board receiving space is formed by the lower and upper housings 102, 103. the cavity 107 is enclosed by the outer shell 101 when the lower and upper housings 102, 103 are brought together and assembled. The lower housing 102 has a base panel 108 and a peripheral lower side wall 109 upstanding from and extending around the base panel 108. The upper housing 103 has a top panel 110 and a peripheral upper side wall 111 downwardly extending from and extending around the top panel 110. The lower and upper side walls 109, 111 together form a side wall of the outer shell 101. Alternatively the side wall of the outer shell 101 may extend from one of the lower and upper housings 102, 103 only.

The upper edge of the lower side wall 109 is arranged to abut against the lower edge of the upper side wall 111 so that the lower and upper housings 102, 103 of engage with each other when they are brought together. One of the lower or upper side walls 109, 111 may have a lip (not shown) to locate the opposing side wall 109, 111. Therefore, the lower and upper housings 102, 103 are positionable relative to each other. The outer shell 101 has an engaging arrangement to retain the lower and upper housings 102, 103 in engagement with each other when the outer shell 101 is assembled.

The outer shell 101 is elongate and the base panel 108 and top panel 110 extend substantially parallel to, but spaced from, each other when the outer shell 101 is assembled. The outer shell 101 has a first PCB receiving region 112 defined in the cavity 107. The outer shell 101 also has a second PCB receiving region 114 defined therein. An FCB receiving region 115 is defined in the cavity 7 between the first and second PCB receiving regions 112, 114.

A first PCB retaining rib 116 extends across the cavity 7. A lower part of the first PCB retaining rib 116 upstands from the base panel 108. An upper part of the first PCB retaining rib 116 upstands from the top panel 110. Alternatively, it will be understood that one of the lower and upper parts of the first PCB retaining rib 116 may be omitted. In such a case, the other part will extend to the opposing surface when the outer shell 101 is assembled or will be spaced there from. The first PCB retaining rib 116 is spaced from an end portion of the lower side wall 109 to define the first PCB receiving region 112. The first PCB retaining rib 116 divides the first PCB receiving region 112 from the FCB receiving region 115. The first PCB retaining rib 116 is usable to maintain a PCB in position in the cavity 107, although it will be understood that the rib 116 may be omitted if an alternative PCB retaining arrangement is used. A gap is formed in the first PCB retaining rib 116 through which an FCB is extendable, as will be explained in detail hereinafter.

A second PCB retaining rib 117 extends across the cavity 7. A lower part of the second PCB retaining rib 117 upstands from the base panel 108. An upper part of the second PCB retaining rib 117 upstands from the top panel 110. Alternatively, it will be understood that one of the lower and upper parts of the second PCB retaining rib 117 may be omitted. In such a case, the other part will extend to the opposing surface when the outer shell 101 is assembled or will be spaced there from. The second PCB retaining rib 117 is spaced from an end portion of the lower side wall 109 to define the second PCB receiving region 114. The second PCB retaining rib 117 divides the second PCB receiving region 114 from the FCB receiving region 115. The second PCB retaining rib 117 is usable to maintain a PCB in position in the cavity 107, although it will be understood that the rib 117 may be omitted if an alternative PCB retaining arrangement is used. A gap is formed in the second PCB retaining rib 117 through which an FCB is extendable, as will be explained in detail hereinafter.

Two FCB positioning ribs 118, 119 are disposed in the FCB receiving region 115. The FCB positioning ribs 118, 119 act as positioning elements to position one or more FCBs in a predetermined position in the lower housing 102. The FCB positioning ribs act to position first and second FCBs relative to each other as will be explained in detail hereinafter. The FCB positioning ribs 118, 119 extend across the cavity 7. A lower part of each FCB positioning rib 118, 119 upstands from the base panel 108 of the lower housing 102. An upper part of each FCB positioning rib 118, 119 upstands from the top panel 110. Alternatively, it will be understood that one of the lower and upper parts of each FCB positioning rib 118, 119 may be omitted. In such a case, the other part will extend to the opposing surface when the outer shell 101 is assembled or will be spaced there from. Alternatively, one end of each FCB positioning rib 118, 119 extends from the top panel 110 and the other end of each FCB positioning rib 118, 119 extends from the base panel 108. The positioning ribs 118, 119 are fixedly disposed in a predetermined position in the cavity 107. The FCB positioning ribs are integrally formed with the base panel 108 and/or top panel 110. In the present arrangement shown in FIG. 1, the positioning ribs 118, 119 are arranged either side of FCBs disposed in the outer shell 101.

Referring to FIG. 2, a lower protrusion 120, or step, is formed in the lower housing 102. The lower protrusion 120 is formed by an indented section of the base panel 108. The lower protrusion 120 is disposed midway along the FCB receiving area 115. The positioning ribs 118, 119 are disposed on either side of the lower protrusion 120. Another protrusion is formed in the upper housing 103. This upper protrusion 122, or step, is formed by an indented section of the top panel 110. The upper protrusion 122 formed in the upper housing 103 is arranged to oppose, but be spaced from, the lower protrusion 120 in the lower housing 102 when the outer shell 101 is assembled.

The lower and upper protrusions 120, 122 form opposing lower and upper mounting elements. The lower and upper protrusions 120, 122 have lower and upper mounting surfaces 123, 124. The lower and upper protrusions 120, 122 are spaced from each other by a predetermined distance when the outer shell 101 is assembled and are configured to be drawn away from each other when the lower and upper housings 102, 103 of the outer shell 101 are separated. The lower and upper mounting surfaces 123, 124 of the protrusions 120, 122 are planar and extend parallel to, but spaced from each other. A first PCB 125 is shown in FIGS. 1 to 3. The first PCB has a rigid non-conductive substrate 126 with a plurality of electrical components 127 mounted thereon. Conductive pathways are formed on a surface of the substrate. A first FCB 128 is electrically connected to the first PCB 125. The first FCB 128 has a flexible non-conductive substrate 129, for example a dielectric polymer film with a number of conductive pathways 130 formed on one face of the substrate 129. The conductive pathways 130 are formed of a metal or a conductive polymer.

Each conductive pathway 130 has a termination 132 at one end of the pathway 130. The terminations 132 are arranged on one face of the substrate 129. The terminations 132 are arranged to be electrically connected to a printed circuit board (PCB), another FCB, or another electrical component, for example an LCD screen. The terminations 132 are conductive pads defined at the end of each pathway 130 which is proximate to or at the edge of the substrate 129. The conductive pads may be tinned pads. The conductive pads may protrude slightly from the face of the substrate. The area of the first face of the FCB 128 on which the terminations 132 are disposed is defined as a first termination section 131.

The first FCB 128 is elongate and has a generally rectangular shape. A distal end of the FCB 128 from the PCB 125 forms an enlarged head portion 133. The head portion 133 has a greater width than the rest of the first FCB 128 between opposing edges. The first termination section 131 of the first FCB 128 is formed at the head portion 133. Alternatively, the enlarged head portion is omitted.

The distance between the opposing positioning ribs 118, 119 along at least one housing corresponds to the width and shape of the first FCB 128 which is to be received there between. Therefore, the first FCB 128 is positionable between the positioning ribs 118, 119 as will be explained hereinafter.

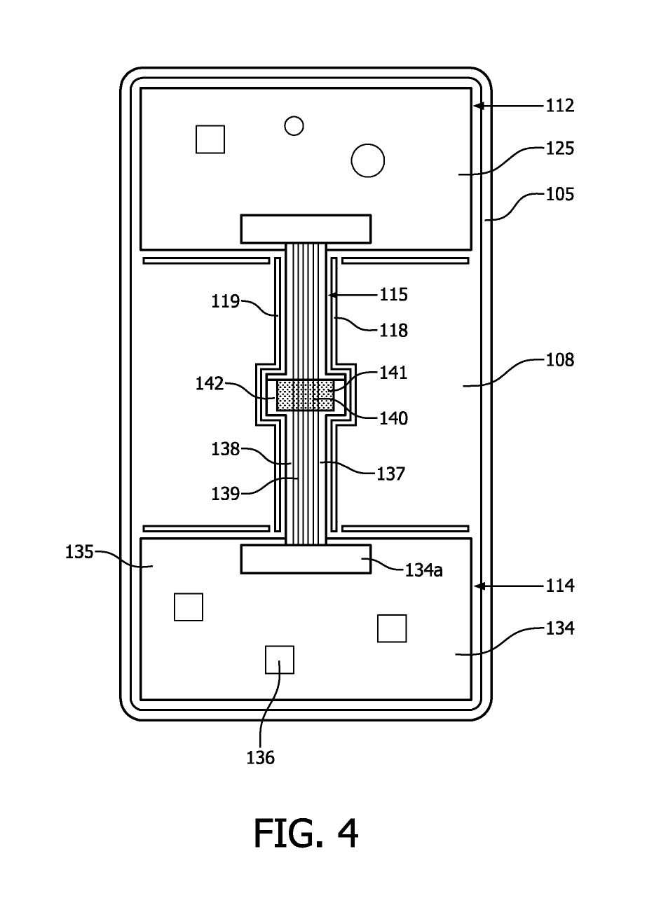

The other end of the first FCB 128 is fixedly mounted to the first PCB 125. The first FCB 128 is mounted to the first PCB 125 and is electrically connected thereto by use of a conventional connector 125a, and so a further description will be omitted herein. A second PCB 134 is shown in FIGS. 1, 2 and 4. The second PCB 134 has a rigid non-conductive substrate 135 with a plurality of electrical components 136 mounted thereon. Conductive pathways are formed on a surface of the substrate. A second FCB 137 is electrically connected to the second PCB 134. The second FCB 137 has a flexible non-conductive substrate 138, for example a dielectric polymer film with a number of conductive pathways 139 formed on one face of the substrate 138. The conductive pathways 139 are formed of a metal or a conductive polymer.

Each conductive pathway 139 has a termination 140 at one end of the pathway 139. The terminations 140 are arranged on one face of the substrate 138. The terminations 140 are arranged to be electrically connected to a printed circuit board (PCB), another FCB or another electrical component. The terminations 140 are conductive pads defined at the end of each pathway 139 which is proximate to or at the edge of the substrate 138. The area of the face of the second FCB 137 on which the terminations 140 are disposed is defined as a termination section 141.

The second FCB 137 is elongate and has a generally rectangular shape. A distal end of the second FCB 137 from the second PCB 134 forms an extended head portion 142. The head portion 142 has a greater width than the rest of the second FCB 137 between opposing edges. The termination section 141 of the second FCB 137 is formed at the head portion 133. Alternatively, the enlarged head portion is omitted.

The distance between the opposing positioning ribs 118, 119 along at least one housing corresponds to the width and shape of the second FCB 137 which is to be received there between. Therefore, the second FCB 137 is positionable between the positioning ribs 118, 119 as will be explained hereinafter.

The other end of the second FCB 137 is fixedly mounted to the second PCB 134. The second FCB 137 is mounted to the second PCB 134 and is electrically connected thereto by use of a conventional connector 134a, and so a further description will be omitted herein.

Assembly of the system for connecting terminations of a flexible circuit board (FCB) directly against terminations of another flexible circuit board or printed circuit board (PCB) will now be described with reference to FIGS. 1 to 4.

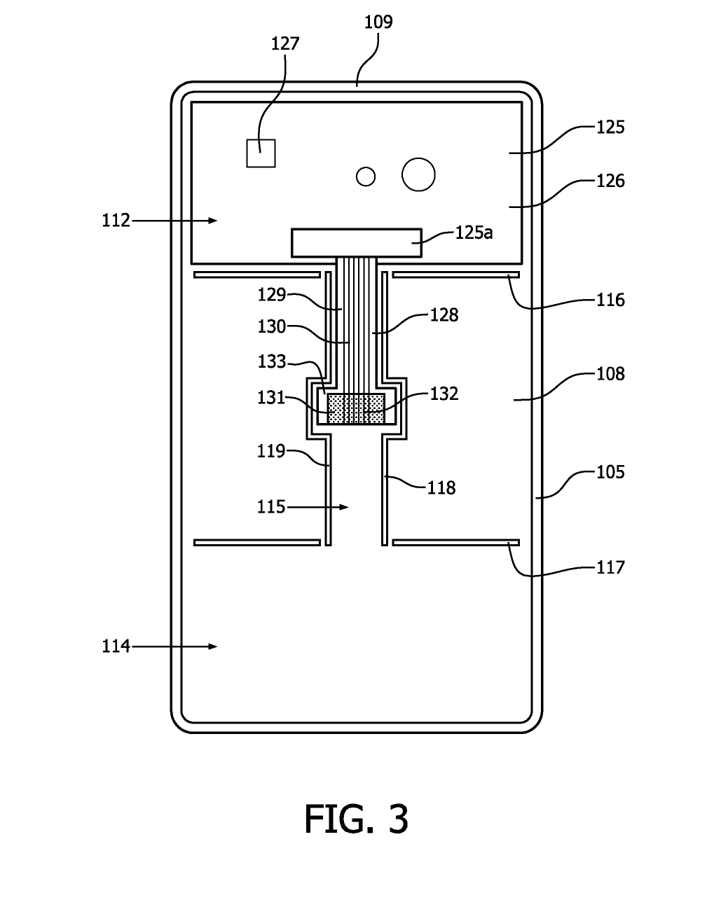

Referring to FIG. 3, the first PCB 125 is received in the lower housing 102. The first PCB 125 is inserted into the first PCB receiving space 112 formed in the lower housing 102. The first PCB 124 is positioned by the lower side wall 109 on three edges and by the first PCB retaining rib 116 along its front edge.

The first FCB 128 extends from the front edge of the first PCB 125. As the first PCB 125 is inserted in the lower housing 102, the first FCB 128 is received in the FCB receiving space 115. The first FCB 128 extends from the first PCB receiving space 112 through the gap in the first PCB retaining rib 116. The first FCB 128 is guided into its correct position by the positioning ribs 118, 119. The positioning ribs 118, 119 position the first FCB 128 between the ribs 118, 119, with the side edges of the FCB 128 lying adjacent to the positioning ribs 118, 119. Therefore the first FCB 128 is prevented from moving laterally in the lower housing 102. The head portion 133 of the first FCB 128 on which the termination section 131 is defined is received midway along the FCB receiving space 115.

A rear side of the head portion 133 locates against the lower mounting surface 123 of the lower protrusion 120. The terminations 132 of the first FCB 128 face away from the lower mounting surface 123 on the other side of the first FCB 128. Therefore, it will be understood that the terminations 132 of the first FCB 128 are exposed.

The second PCB 134 is received in the upper housing 103. The second PCB 134 is inserted into the second PCB receiving space 114 formed in the upper housing 103. The second PCB 134 is positioned by the upper side wall 111 on three edges and by the second PCB retaining rib 117 along its front edge.

The second FCB 137 extends from the front edge of the second PCB 134. As the second PCB 134 is inserted into the upper housing 103, the second FCB 137 is received in the FCB receiving space 115. The second FCB 137 extends from the second PCB receiving space 114 through the gap in the second PCB retaining rib 117. The second FCB 137 is guided into its correct position by the positioning ribs 118, 119. The positioning ribs 118, 119 position the second FCB 137 between the ribs 118, 119, with the edges of the FCB 137 lying adjacent to the positioning ribs 118, 119. Therefore the second FCB 137 is prevented from moving laterally in the upper housing 103. The second FCB 137 extends along the FCB receiving space 115 and the head portion 142 of the second FCB 137, on which the termination section 141 is defined, is received midway along the FCB receiving space 115.

A rear side of the head portion 142 locates against the upper mounting surface 124 of the upper protrusion 122. The terminations 140 of the second FCB 137 face away from the upper mounting surface 124 on the other side of the second FCB 137. Therefore, it will be understood that the terminations 140 of the second FCB 137 are exposed.

The upper housing 103 is then brought together with the lower housing 102. The upper housing 103 is correctly aligned with the lower housing 102 and the lower and upper side walls 109, 111 are brought into contact with each other. As the upper and lower housings 103, 104 are brought together, the upper protrusion 122 of the upper housing 103 is guided towards the lower protrusion 120 of the lower housing 102. The housings 102, 103 are configured so that the head portion 142 of the second FCB 137 overlaps the head portion 133 of the first FCB 128 when the upper housing is brought together with the lower housing 102.

The combined length of the two FCBs is greater than the length of the FCB receiving space 115 defined in the cavity 107 enclosed by the housings 102, 103. The second FCB 137 is disposed in the upper housing 103 so that the terminations 140 of the second FCB 137 face outwardly and are exposed in the lower housing 102. The second FCB 137 partially overlaps the first FCB 128 as the lower and upper housings 102, 103 are coupled to each other. Therefore, the termination section 141 of the second FCB 137 is configured to overlap and face the termination section 131 of the first FCB 128 when the lower and upper housings 102, 103 are coupled to each other. Therefore, the terminations 140 of the second FCB 137 oppose the terminations 132 of the first FCB 128.

The terminations 132, 140 of the two FCBs face each other and are therefore in loose contact with each other as the housings are brought together, but prior to coupling of the housings to each other. The terminations 132 of the first FCB 128 align with the terminations 140 of the second FCB 137 due to the FCB positioning ribs 118, 119 acting as positioning elements and positioning both of the FCBs in a predetermined position in the cavity 107. Therefore, the terminations 132, 140 of the opposing FCBs 128, 137 are easily aligned with each other and oppose each other in the cavity 107.

The lower and upper protrusions 120, 122 protrude into the cavity 107 towards each other. The termination sections 131, 141 of the first and second FCBs 128, 137 are received between the lower and upper protrusions 120, 122 forming opposing lower and upper mounting elements. The PCBs 125, 134 are disposed in the first and second PCB receiving regions 112, 114 and so the PCBs are retained in position in the outer shell 101 by the side wall of the outer shell 101 and the first and second PCB retaining ribs 116, 117 respectively.

The lower housing 102 mounts with the upper housing 103 so that the lower and upper housings 102, 103 are coupled to each other. The coupling arrangement to fixedly couple the lower and upper housings to each other may, for example, be one or more clips, a threaded element extending through one of the housings and threadingly engaging in the opposing housing, or the like. As the two housings 102, 103 are moved into engagement with each other the first and second termination sections 131, 141 of the FCBs 128, 137 are disposed between the first and second mounting surfaces 123, 124 of the lower and upper protrusions 120, 122.

It will be understood that the distance between the lower and upper mounting surfaces 123, 124 of the protrusions 120, 122 is configured to be equal to or less than the combined thickness of the first and second FCBs 128, 137 at their termination sections 131, 141. That is, the thickness of the first FCB 128 at the first termination section 131 is the distance between the rear surface of the substrate 129 and the contact surface of the terminations 132. Similarly, the thickness of the second FCB 137 at the second termination section 141 is the distance between the rear surface of the substrate 138 and the contact surface of the terminations 140. Alternatively it is understood that the protrusions 120, 122 may be omitted as long as the distance between the positioning surfaces for the two opposite terminations of the FCBs/PCBs are equal or less than the thickness of the circuits to be brought into contact.

When the outer shell 101 is assembled, the termination sections 131, 141 of the first and second FCBs 128, 137 are urged against each other by the lower and upper protrusions 120, 122 forming lower and upper mounting elements. The FCBs are sandwiched between the opposing mounting elements of the lower and upper housings 102, 103. Therefore, the terminations 132, 140 of the two FCBs 128, 137 are urged against each other and are retained in position with respect to each other. The opposing terminations 132, 140 are put under a slight and evenly distributed compression against each other. This ensures that a good electrical contact is obtained between the terminations 132, 140.

An advantage of the above arrangement is that it enables the terminations of two FCBs to be simply positioned against each other and to be urged into electrical contact with each other. It will be understood that such an arrangement does not require the use of any additional or intermediate connector. Furthermore, it will be appreciated that the polarity of the terminations may be mirrored along the central axis of a termination group. The connection will be genderless, for example the FCBs will be interchangeable with each other. Furthermore, it will be appreciated that the terminations of the two FCBs are in direct contact with each other.

To disconnect the two FCBs 128, 137 from each other, the lower and upper housings 102, 103 are disengaged from each other. The lower and upper housings 102, 103 are drawn away from each other, and so the lower and upper protrusions 120, 122 forming lower and upper mounting elements are moved away from each other. The compressive force acting on the termination sections 131, 141 of the FCBs 128, 137 is therefore released and the terminations 132, 140 of the opposing FCBs are drawn away from each other. Therefore, an advantage of the above arrangement is that the terminations 132, 140 of the opposing FCBs 128, 137 are not permanently mounted to each other.

In the above embodiment the termination sections 131, 141 of the first and second FCBs 128, 137 are disposed between opposing protrusions 120, 122 forming lower and upper mounting elements. However, it will be appreciated that in an alternative embodiment the outer shell may have a single protrusion acting as a mounting element formed by either the lower housing 102 or upper housing 103. In such an arrangement, the single protrusion, acting as a mounting element, is configured to be disposed proximate to, but spaced from, the opposing base panel of the lower housing 102 or top panel 110 of the upper housing 110 when the housings 102, 103 are coupled to each other. The mounting face of the protrusion is configured to be spaced from the base or top panel by a predetermined distance when the outer shell is assembled so that the termination sections 131, 141 of two FCBs, which are disposed there between and positioned against each other, are urged against each other. Therefore, the terminations of the two FCBs are placed and held in electrical contact with each other.

With the above arrangement, it is possible to easily position each of the FCBs independently of each other and to then simply assembly the outer shell to locate the terminations of the first FCB and the terminations of the second FCB or PCB in direct contact with each other. Similarly, with such an arrangement, the two housings leave the terminations exposed until the two housings are brought together and the outer shell assembled. It will be understood that the system may be modular and that one of the housings may then be easily replaced with another housing with another PCB and FCB received therein. Therefore, one housing and/or FCB is interchangeably connectable to another housing and/or FCB.

In an alternative arrangement the first PCB and first FCB are mounted to the lower housing by a first PCB retaining means and first FCB positioning element, for example by one of the positioning arrangements described above. The second PCB and second FCB are also mounted to the lower housing by a second PCB retaining means and second FCB positioning element, for example by one of the positioning arrangements described above. The first and second PCBs and first and second FCBs are received in the lower housing 102 prior to assembly of the lower and upper housings 102, 103 to each other. The upper housing is then brought together with the lower housing 103 and is coupled thereto. As the upper housing 103 is coupled to the lower housing 102, the upper protrusion 122 locates against the rear side of the second FCB to the terminations 140. Therefore, the termination sections 131, 141 of the first and second FCBs 128, 137 are urged against each other by the lower and upper protrusions 120, 122 forming lower and upper mounting elements. The FCBs are sandwiched between the opposing mounting elements of the lower and upper housings 102, 103. Therefore, the terminations 132, 140 of the two FCBs 128, 137 are urged against each other and are retained in position with respect to each other.

Although the indented protrusions of the base panel 108 and top panel 110 of the lower and upper housings 102, 103 act as FCB mounting elements in the above embodiments, it will be understood that alternative arrangements of locating the terminations of the first FCB) and the terminations of the second FCB or a PCB in direct contact with each other are envisaged. The mounting elements are arranged to locate the terminations of one FCB in direct contact with the terminations of another FCB or PCB. Each contacting mounting element urges the terminations of one FCB against the terminations of another FCB or PCB to ensure that there is a good electrical contact between the respective terminations of each FCB, or between a FBC and a PCB.

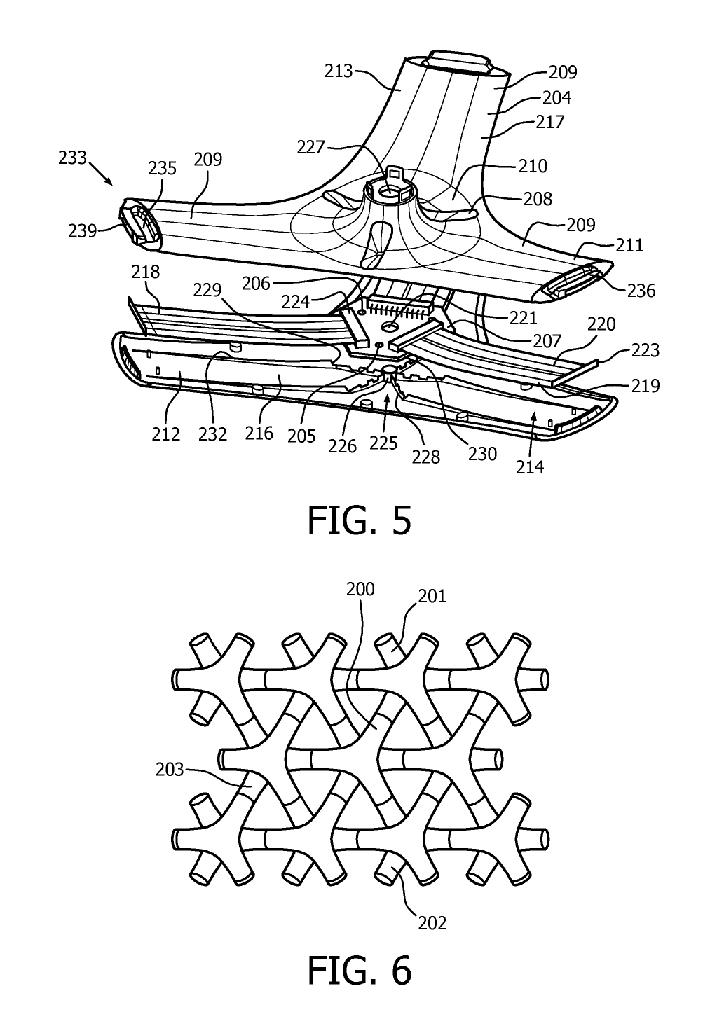

Referring now to FIGS. 5 to 9, the system for connecting terminations of an FCB against terminations of another FCB will be described for mounting lighting modules to each other. The arrangement and configuration of many of the components and features are generally the same as described above.

Referring to FIGS. 5 and 6, a lighting module 200 is shown. The lighting module 200 is configured to be mounted to other lighting modules. In the present arrangement, this first lighting module 200 is arranged to be mounted to three other lighting modules—a second lighting module 201, a third lighting module 202, and a fourth lighting module 203. Each of these other lighting modules 201, 202, 203 are also arranged to be mounted to further lighting modules, as shown in FIG. 6. The lighting modules 200, 201, 202, 203 are generally the same and so only the first lighting module 200 will be described in detail herein. However, it will be understood that the lighting modules are interchangeable with each other.

The lighting module 200 comprises a housing 204 and a light source 205. The light source 205 comprises three light emitting diodes (LEDs) 206 which are spaced from each other. The three LEDs 206 are fixedly mounted to a PCB 207 in a spaced relationship. However, it will be understood that alternative light sources may be used. Openings 208 are formed in the housing 204 through which each LED 206 is able to emit light when the lighting module 200 is operated.

The housing 204 has three arms 209 extending from a mid-section 210. The three arms 209 extend radially from the mid-section 210. A free end 211 of each arm is spaced equidistant from the arms disposed on each side. The housing 204 comprises a lower part 212 and an upper part 213. The lower and upper parts 212, 213 are formed from a rigid molded material, for example a plastic, however it will be understood that alternative materials may be used. The lower and upper parts 212, 213 are fixedly mounted to each other and a chamber 214 is defined in the housing 204. The lower part 212 of the housing 204 has a base panel 216. The upper part 213 of the housing 204 has a panel wall 217 which is spaced from the base panel 216. Although three arms 209 are described herein, it will be understood that the housing may have an alternative number of arms, or may have a different arrangement without arms extending from a mid-section.

The PCB 207 is received in the chamber 214 defined in the housing. Three FCBs, acting as electrical connectors, are also received in the chamber 214. The PCB 207 is disposed in the mid-section 210 of the housing 204. The PCB 207 has a rigid non-conductive substrate with a plurality of electrical components mounted thereon. The electrical components include the LEDs 206. Conductive pathways are formed on a surface of the substrate. Although a PCB is described herein, an alternative electrical arrangement may be used. A hole 221 is formed through the substrate of the PCB 207.

Three FCBs 218 are electrically connected to the first PCB 125. Each FCB 218 has a flexible non-conductive substrate 219, for example a dielectric polymer film with a number of conductive pathways 220 formed on one face of the substrate 219. The conductive pathways 220 are formed of a metal or a conductive polymer.

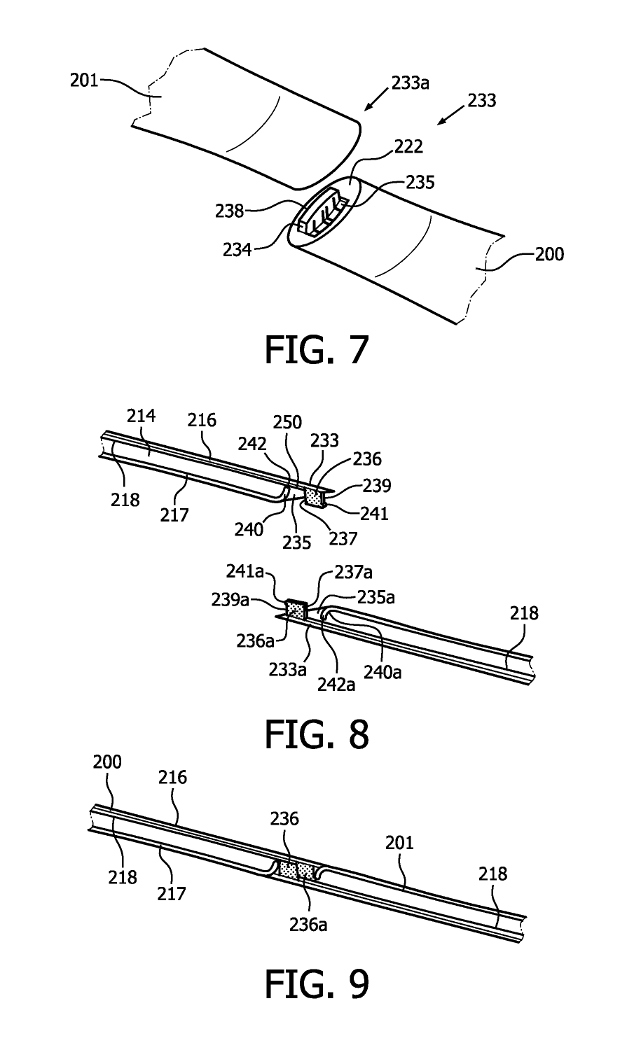

Each conductive pathway 220 has a termination 222 (refer to FIG. 7) at one end of the pathway 220. The terminations 222 are arranged on one face of the substrate 219. The terminations 220 are arranged to be electrically connected to a PCB, another FCB, or another electrical component. The terminations 222 form a termination section 223. The termination section is defined at the end of each pathway 220 which is proximate to or at a free end of the substrate 219. The terminations 222 may be conductive pads, such as tinned pads. The conductive pads may protrude slightly from the face of the substrate.

Each FCB 218 is elongate and has a generally rectangular shape. The distal end of each FCB 218 to the termination section 223 is fixedly mounted to the PCB 207. Each FCB 218 is mounted to the PCB 207 and is electrically connected thereto by use of a conventional connector 224, and so a further description will be omitted herein.

Each FCB 218 extends radially from the PCB 207. The FCBs 218 are spaced equidistant from each other around the PCB 207. However, it will be understood that the arrangement and orientation of each FCB 218 may be varied dependent on the desired arrangement of the PCB and FCBs.

A PCB retaining unit 225 is formed in the housing 204. The PCB retaining unit 225 upstands in the chamber 214. The PCB retaining unit 225 comprises a first hollow cylindrical tube 226 upstanding from an inner surface 250 of the base panel 216 of the lower part 212. The hollow cylindrical tube 226 extends in the chamber 214. The bore of the first cylindrical tube 226 extends from a housing mounting hole (not shown) formed in the base panel 216. A second hollow cylindrical tube (not shown) downwardly extends from an inner surface of the panel wall 217 of the upper part 214. The bore of the second cylindrical tube extends from a housing mounting hole 227 formed in the panel wall 217. The first cylindrical tube 226 is configured to be received through the hole 221 formed through the substrate of the PCB 207. This arrangement aids positioning and retention of the PCB 207 in the housing 204.

The first cylindrical tube 226 is configured to be received in the bore of the second cylindrical tube when the lower and upper parts 216, 217 of the housing 204 are brought together. This aids alignment of the lower and upper parts 216, 217 of the housing 204 with each other.

The PCB retaining unit 225 also comprises PCB retaining ribs 228 upstanding from the inner surface 250 of the base panel 216. Alternatively, the PCB retaining ribs may downwardly extend from the inner surface of the panel wall 217 of the upper part 213. The PCB retaining ribs 228 have protruding end walls 229. The end walls 229 abut against an outer edge 230 of the PCB 207 to locate the PCB in the correct position in the housing 204. The end walls 229 form an end of FCB retaining ribs, as will be described below. The end walls 229 and PCB retaining ribs 228 define a PCB receiving region. The PCB retaining unit 225 is usable to maintain the PCB 207 in position in the chamber 214, although it will be understood that one of the first cylindrical tube 226, PCB retaining ribs 228 or end walls 229 may be omitted, or an alternative PCB retaining arrangement may be used.

FCB positioning ribs 232 are formed in the chamber 214 of the housing 204. The FCB positioning ribs 232 act as positioning elements to position the FCBs in a predetermined position in the housing 204. Two FCB positioning ribs 232 extend along each arm 209. Each pair of FCB positioning ribs 232 extend parallel, but spaced from each other. Each pair of FCB positioning ribs 232 extend in a radial direction from the PCB receiving region. The FCB positioning ribs 232 upstands from the inner surface 250 of the base panel 216 of the lower part 212. Alternatively, it will be understood that the FCB positioning ribs may extend downwardly from the inner surface of the panel wall 217 of the upper part 213. The FCB positioning ribs are integrally formed with the base panel 216. Each pair of FCB positioning ribs 232 are spaced apart to receive an FCB there between, so that each FCB is located in a desired position in the housing 204. The distance between the opposing positioning ribs 232 corresponds to the width and shape of the FCB which is to be received there between. Therefore, the FCB 218 is positionable between the positioning ribs, as will be explained hereinafter.

A mounting unit 233 is formed at the free end 211 of each arm 209. Each mounting unit 233 of the housing 204 is configured to couple to a corresponding mounting unit of a housing of another lighting module 201, 202, 203 (refer to FIG. 8).

One of the mounting units 233 will now be described. Each of the mounting units 233 is generally the same. The mounting unit 233 has a locating face 234. The locating face 234 is arranged to abut against the locating face of another mounting unit when the housings of two lighting modules 200, 201, 202, 203 are brought together.

An aperture 235 is formed in the locating face 234. The aperture 235 communicates with the chamber 214 defined in the housing 204. The aperture is generally elongate and extends perpendicular to the longitudinal axis of the arm 209 in which the aperture 235 is formed.

A protrusion 236, or step, extends from one edge of the aperture 235. The protrusion 236 forms the edge of the aperture 235 proximate to the end of the arm 209. The FCB positioning ribs 232 extend proximate to either side of the protrusion 236. The protrusion 236 forms a mounting element. An inner surface 237 of the protrusion 236 forms a mounting surface 237. The mounting surface 237 extends at an acute angle to the inner surface 250 of the base panel 216. The protrusion 236 forms a wedge, with the mounting surface 237 forming a wedge surface. The mounting surface 237 is planar. The mounting surface 237 extends perpendicular to the line of the FCB positioning ribs 232. An outer surface 238 of the protrusion has an elongate slot 239 formed in it. The slot 239 forms an engaging ridge 241 on the outer surface 238 of the protrusion, and forms part of an engaging arrangement to engage with an engaging arrangement of another opposing mounting section, to couple the housing of the lighting module to another lighting module. Therefore, the lighting modules are able to be coupled to each other.

The opposing edge of the aperture 235 to the protrusion 236 has an engaging flap 240. The flap 240 extends inwardly from the planar wall 217 of the housing 204 towards the base panel 216. The flap 240 is resilient. A free edge 242 of the engaging flap 240 is arranged to engage with an opposing engaging ridge 241 on the housing of another lighting module.

When the lighting module 200 is assembled, the PCB 207 is received in the housing 204. The PCB 207 is mounted in the PCB receiving space 225. The PCB 207 is located against the PCB retaining ribs 228, with the first hollow cylindrical tube 226 extending through the hole 221 formed through the PCB substrate. The PCB retaining ribs 228 have protruding end walls 229. The end walls 229 abut against an outer edge 230 of the PCB 207 to locate the PCB in the correct position in the housing 204. Therefore, the PCB retaining unit maintains the PCB 207 in position in the chamber 217.

The FCBs 218 extend from the PCB 207. Each FCB 218 is received in the chamber 214. The FCBs 218 are guided into their correct position by the FCB positioning ribs 232. The positioning ribs 232 position each FCB 218 between parallel, spaced ribs, with the side edges of each FCB 218 lying on top of the positioning ribs 232. The FCBs are held laterally by their fitting through the cavity 235 at each arms end, and furthermore through small pegs (not shown) on shell 225 onto which the FCB is inserted. Therefore the FCBs 218 are prevented from moving laterally in the chamber 214. The rear side of the substrate 219 of each FCB 218 abuts and lies against the inner surface 250 of the base panel 216 of the housing 204.

When the upper part 213 is brought together with the lower part 214, the PCB 207 and FCBs 218 are received there between. The first cylindrical tube 226 is received in the bore of the second cylindrical tube. This aids alignment of the lower and upper parts 216, 217 of the housing 204 with each other. A connector element (not shown) extends through the bores and extends from the housing mounting holes formed in the lower and upper parts 216, 217 and fixedly mounts the lower and upper parts 216, 217 of the housing 204 to each other. Alternatively, other fixing means may be used.

The termination section 223 of each FCB 218 protrudes into the aperture 235. The rear side of the termination section 223 locates against the mounting surface 237 of the protrusion 236. The terminations 220 of the FCB 218 face away from the mounting surface 237 on the other side of the FCB 218. Therefore, it will be understood that the terminations 220 of each FCB 218 are exposed at the aperture 235.

The lighting module 200 is therefore, assembled, with the LEDs 206 aligned with the openings 208 formed in the housing 204 through which each LED 206 is able to emit light when the lighting module 200 is operated. The PCB and FCBs are disposed in the lighting module 200 and are retained in their desired position with respect to the housing 204. It will be understood that the lighting module 200 is supplied to a user in its assembled state. Mounting of the lighting modules to each other will now be described with reference to the mounting of the first lighting module 200 to the second lighting module 201. It will be understood that the operation is repeatable to mount additional lighting modules 202, 203 to the system.

A user grasps the first lighting module 200 and orientates it with respect to the second lighting module 201. The mounting unit 233 of the first lighting module 200 is orientated to face the mounting unit 233a of the second lighting module 201. That is, the protrusion 236 of the first lighting module 200 is positioned to oppose the aperture 235a of the second lighting module 201. It will be understood that the protrusion 236a of the second lighting module 201 will therefore also be positioned to oppose the aperture 235 of the first lighting module 200.

The first lighting module 200 is then brought together with the second lighting module 201. The protrusion 236 of the first lighting module 200 is guided into and received in the aperture 235a of the second lighting module 201, and the protrusion 236a of the second lighting module 201 is guided into and received in the aperture 235 of the first lighting module 200.

As the protrusions 236, 236a are inserted in the apertures 235, 235a the mounting surfaces 237 of the protrusions overlap each other. The termination section 223 of each FCB 218 lies against the mounting surfaces 237, 237a, and so the termination section 223 of the FCB of the second lighting module 201 overlaps the termination section 223 of the FCB of the first lighting module 200 when the mounting units 233, 233a are brought together. The termination sections 223 slide against each other, which acts to remove any detritus from the contact surface of the terminations 220. Therefore, the terminations of each lighting module are brought into contact with each other. The termination sections are configured to overlap and face each other when the lighting modules are coupled to each other.

The terminations of the two FCBs face each other and are therefore in contact with each other as the housings are brought together, but prior to coupling of the housings to each other. The terminations 220 of the FCB 218 of the first lighting module 200 align with the terminations 220 of the FCB 218 of the second lighting module 201 due to the protrusions being received in the apertures 235, 235a and so acting to locate the FCBs in a predetermined position relative to each other. Therefore, the terminations of the opposing FCBs 218 are easily aligned with each other and oppose each other.

As the protrusions 236, 236a of the two lighting modules are inserted into the apertures 235, 235a, the engaging flap 240 of each mounting unit 233 locates against the outer surface 238 of the corresponding protrusion 236. The protrusion 236 slides along the flap 240 until the free edge 242 of the flap 240 is aligned with the urged into the slot 239 formed in the outer surface 238. As the locating faces 234 of the lighting modules 200, 201 are brought into contact with each other, the free edge 242 of the flap 240 locates over the engaging ridge 241 and locates in the slot 239. Therefore, the mounting unit 233 of the first lighting module 200 is engaged with the mounting unit 233a of the second lighting module 201. The first and second lighting modules 200, 201 are then coupled to each other.

It will be understood that the terminations of the two FCBs face each other and are in electrical contact with each other. The flaps 240, 240a act on the outer surfaces 238 of the protrusions 236, 236a and so bias the protrusions towards each other. The FCBs are sandwiched between the opposing mounting elements and so, the terminations 222 of the FCBs are urged against each other to ensure a good electrical contact.

It will be understood that the distance between the mounting surfaces 237, 237a of the protrusions 236, 236a is configured to be equal to the combined thickness of the termination sections of the two FCBs 218 received there between. The opposing terminations 222 are put under a slight and evenly distributed compression against each other. This ensures that a good electrical contact is obtained between the terminations.

An advantage of the above arrangement is that it enables the terminations of two FCBs to be simply positioned against each other and to be urged into electrical contact with each other. It will be understood that such an arrangement does not require the use of any additional or intermediate connector. Furthermore, it will be appreciated that by not requiring any additional or intermediate connector, the connection is also genderless. Furthermore, it will be appreciated that the terminations of the two FCBs are in direct contact with each other.

To disconnect the two FCBs from each other, the lighting modules are disengaged from each other. That is, the first and second lighting modules are drawn away from each other. The flaps disengage from the slots 239, and the protrusions 236, 236a are withdrawn from the apertures 235, 235a. The compressive force acting on the termination sections 223 of the FCBs is therefore released and the terminations 222 of the opposing FCBs are drawn away from each other. Therefore, an advantage of the above arrangement is that the terminations 222 of the opposing FCBs are not permanently mounted to each other.

It will be understood that by coupling multiple lighting modules to each other it is possible for a complete lighting system to be created. An advantage of such a lighting system is that there is no requirement for additional connecting elements to be used. Although the positioning ribs 118, 119, 232 and/or pegs act as positioning elements in the above described embodiments to align the FCBs in the housings, as well as the protrusions and apertures in the above embodiment, it will be understood that alternative FCB positioning means are envisaged. The positioning elements for positioning FCBs are configured to position one or more FCBs in the housing, and to position corresponding first and second FCBs so that the terminations of first and second FCBs 128, 137 are aligned with each other in the housing 101 so that they are or can be brought into electrical contact with each other.

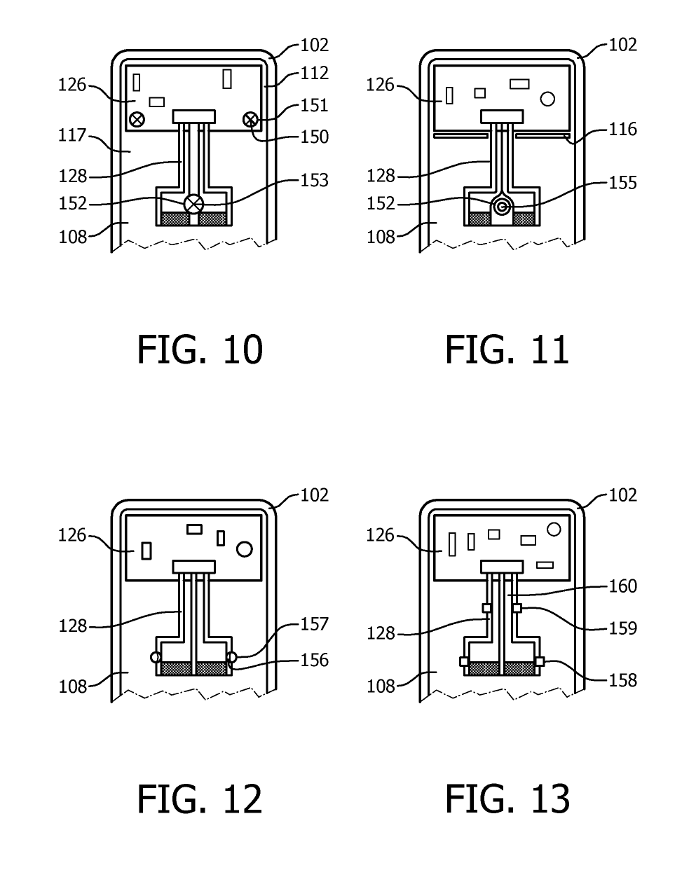

For example, an alternative form of a positioning means is shown in FIG. 10. Reference numerals are retained from above-described embodiments for like elements. In FIG. 10 a partial view the lower housing 102 is shown. In this arrangement the positioning ribs are omitted. A first PCB 126 is received in the cavity 107 and is disposed at one end of the cavity 107. The PCB retaining ribs are also omitted from this arrangement. Two PCB retaining elements 150 extend through holes 151 formed in the PCB 126 and are fixedly mounted to the base panel 8 of the lower housing 102. The PCB retaining elements 150 may be threaded elements, for example screws, which are threadingly engaged with corresponding threaded holes 151 formed in the base panel 108. The holes 151 in the first PCB 126 are formed to align with the threaded holes formed in the lower housing 102 when the first PCB 126 is received in the cavity 107.

A first FCB 128 extends from one edge of the first PCB 125. When the first PCB 125 is received in the cavity 107, the first FCB 128 is also received in the cavity 107. The first PCB 125 is retained in the cavity by the PCB retaining elements 150 extending through the holes 151 in the PCB and threadingly engaging with the lower housing 102.

An aperture 152 is formed through the first FCB 128. When the first FCB 128 is received in the cavity 107, the FCB 128 is positioned by a threaded element 153, such as a screw, extending through the aperture 152 and being threadingly engaged in a corresponding threaded hole in the base panel 108 of the lower housing 102. The threaded element 153 acts as a positioning element. Therefore the first FCB 128 is prevented from moving laterally in the lower housing 102. The termination section 131 is then positioned in the correct position to be aligned with and located against the termination section of a second FCB received in the outer shell.

Once the first PCB 126 and first FCB are positioned in the cavity 107, a second PCB with a second FCB extending there from (not shown in FIG. 10) are received in the cavity 107. The second PCB is received in the cavity 107 and is disposed at the other end of the cavity 107 to the first PCB 126. The second PCB is positioned in the outer shell 101 by threaded elements, acting as PCB retaining elements, extending through holes formed in the base panel 108. The second FCB, extending from the second PCB, has an aperture formed there through. The second FCB is positioned by a threaded element, acting as a positioning element, extending through the aperture and being threadingly engaged in a corresponding threaded hole formed in the base panel 108. Therefore the second FCB is prevented from moving laterally in the housing 101. The termination section of the second FCB is then positioned in the correct position in the lower housing 102 so that it is aligned with and overlaps the termination section of the first FCB.

The outer shell 101 is then assembled as described in the above embodiment, and shown in FIG. 2, so that the terminations of the first and second FCBs are disposed between opposing protrusions forming lower and upper mounting elements. Therefore, the terminations of the first and second FCBs are located in electrical contact with each other.

Alternatively, it will be understood that in another arrangement the threaded elements, acting as positioning elements, act as the engaging arrangement to fixedly mount the lower and upper housings 102, 103 to each other. In this arrangement, the PCBs and FCBs are received in the cavity 107 and the lower and upper housings 102, 103 are brought together. The threaded elements, acting as FCB positioning elements, are then inserted through corresponding holes in one of the housings and pass through the respective apertures formed in the FCBs. The threaded elements threadingly engage in the opposing housing, for example the lower housing, and is operable to fixedly mount the lower and upper housings 102, 103 to each other. Therefore, the positioning elements act to engage the lower and upper housings as well as to position the FCBs in the outer shell 101.

It will also be understood that a positioning element may be used to position both the first and second FCBs in position in the outer shell 101. As the termination sections of the first and second FCBs overlap each other, an aperture may be formed in each of the termination sections and the apertures may align with each other when the FCBs are received in the outer shell 101. Therefore, a single positioning element may be used to position both the first and second FCBs with respect to each other.

An alternative form of a positioning means is shown in FIG. 11. Reference numerals are retained from above-described embodiments for like elements. In FIG. 11 a partial view the lower housing 102 of the outer shell 101 is shown. The first PCB 126 is received in the cavity 107 at one end. The first PCB 126 is retained in position by a retaining rib 116, acting as a retaining element. The retaining rib 116 is generally the same as the retaining rib described above and shown in FIGS. 6 to 9.

A first FCB 128 extends from one edge of the first PCB 125. When the first PCB 125 is received in the cavity 107, the first FCB 128 is also received in the cavity 107. An aperture 152 is formed through the first FCB 128. When the first FCB 128 is received in the cavity 107, the FCB 128 is positioned by a positioning element, for example a peg element 155. The peg element 155 extends through the aperture 152 in the FCB 128. The peg element 155 is received in a hole in the base panel 108. The peg element 155 may be push fitted in the hole in the base panel 108 to retain the peg element 155 in position. Therefore the first FCB 128 is prevented from moving laterally in the lower housing 102 due to the FCB 128 abutting against the peg element 155. The termination section 131 is then positioned in the correct position in the outer shell 101 to be aligned with and located against the termination section of a second FCB received in the outer shell.

A second PCB with a second FCB extending there from (not shown in FIG. 11) is received in the cavity 107. The second PCB is retained in position in the cavity 107 by another retaining rib (not shown in FIG. 11). The second FCB, extending from the second PCB, has an aperture formed there through. The second FCB 134 is positioned by another positioning element, for example a peg element (not shown). The peg element extends through the aperture in the FCB. The peg element is received in a hole in the base panel 108. The peg element may be push fitted in the hole to retain the peg element in position. Therefore the first FCB 128 is prevented from moving laterally in the lower housing 102 due to the second FCB abutting against the peg element. The termination section of the second FCB is then positioned in the correct position in the outer shell 101 so that it is aligned with and overlaps the termination section of the first FCB.

The outer shell 101 is then assembled as described in the above embodiments, and shown in FIG. 2, so that the terminations of the first and second FCBs are disposed between opposing protrusions forming lower and upper mounting elements. Therefore, the terminations of the first and second FCBs are located in electrical contact with each other.

It will also be understood that a peg element may be used to position both the first and second FCBs in position in the outer shell 101. As the termination sections of the first and second FCBs overlap each other, an aperture may be formed in each of the termination sections and the apertures may align with each other when the FCBs are received in the outer shell 101. Therefore, a single peg element may extend through the aperture formed in each FCB and be used to position both the first and second FCBs with respect to each other.

The or each peg element, acting as a positioning element, may be a discrete member which is received in the hole in the outer shell. Alternatively, the peg element may extend from the upper housing 103 through the aperture in the respective FCB.

Alternatively, the or each peg element may be integrally formed with the lower housing and upstand from the base panel of the lower housing.

An alternative form of a positioning means is shown in FIG. 12. Reference numerals are retained from above-described embodiments for like elements. In FIG. 12 a partial view the lower housing 102 is shown. This arrangement is generally the same as the arrangement described above and shown in FIG. 11. However, in this embodiment cut-outs 156 are formed in either edge of the first FCB 128 and a peg element 157, acting as a positioning element, is received in each cut-out when the first FCB is received in the cavity 107. The two peg elements 157 may be integrally formed with the lower housing 102 and upstand from the base panel 108 of the lower housing 102. Therefore the first FCB 128 is prevented from moving laterally in the outer shell 101 due to the FCB 128 abutting against the peg elements 157. The termination section 131 is then positioned in the correct position in the outer shell 101 to be aligned with and located against the termination section of a second FCB received in the outer shell.

A second set of peg elements locate in corresponding cut-outs in a second FCB (not shown in FIG. 12) when the second FCB is received in the cavity 107. Therefore, the second PCB is retained in position in the cavity 107 by the peg elements. The termination section of the second FCB is therefore positioned in the correct position in the lower housing 102 so that it is aligned with and overlaps the termination section of the first FCB.

The outer shell 101 is then assembled as described in the above embodiments, and shown in FIG. 2, so that the terminations of the first and second FCBs are disposed between opposing protrusions forming lower and upper mounting elements. Therefore, the terminations of the first and second FCBs are located in electrical contact with each other.

It will also be understood that one set of peg elements may be used to position both the first and second FCBs in position in the outer shell 101. As the termination sections of the first and second FCBs overlap each other, the cut-outs may align with each other when the FCBs are received in the outer shell 101. Therefore, a single set of peg elements may be used to position both the first and second FCBs with respect to each other.

An alternative form of a positioning means is shown in FIG. 13. Reference numerals are retained from above-described embodiments for like elements. In FIG. 13 a partial view the lower housing 102 is shown. This arrangement is generally the same as the arrangement described above and shown in FIGS. 10 to 12. However, in this embodiment latches 158, acting as positioning elements, upstand from the base panel 108 of the lower housing 102. Each latch 158 has a tab section 159 which is configured to overlap a front face 60 of the first and second FCBs when the FCBs are received between opposing latches 158.

The FCB positioning latches 158 are integrally formed with the base panel 108. Positioning latches 158 are arranged either side of the FCBs disposed in the lowerhousing 102. The distance between opposing positioning latches 158 corresponds to the dimensions of the FCB which is to be received there between. Therefore, the FCBs are positionable between the positioning latches 158.

When the first FCB 128 is received in the cavity 107, the edges of the FCB 128 are able to slide over the tab section 159 of each latch 158 due to the resilience of the substrate of the FCB. Alternatively, the latches may be resilient. Therefore the first FCB 128 is prevented from moving laterally in the lower housing 102 due to the FCB 128 abutting against the latches 158. The termination section 131 is then positioned in the correct position to be aligned with and located against the termination section of a second FCB received in the outer shell.

The second FCB (not shown in FIG. 13) is received between opposing latches 158 and is retained in position in the cavity 107 by the latches 158. The second FCB is prevented from moving laterally in the outer shell 1 due to the FCB abutting against the latches 158. The termination section of the second FCB is therefore positioned in the correct position so that it is aligned with and overlaps the termination section of the first FCB.

In FIG. 13 four latches 158 are shown overlapping the edges of the first FCB 128 to retain the first FCB in position, although it will be understood that an alternative number of latches may be used. An advantage of using latches is that they overlap the first and second FCBs and so prevent the first and second FCBs from moving away from the base panel 108 of the lower housing 102 prior to the outer shell being assembled.

The outer shell 101 is then assembled as described in the above embodiments, and shown in FIG. 2, so that the terminations of the first and second FCBs are disposed between opposing protrusions forming lower and upper mounting elements. Therefore, the terminations of the first and second FCBs are located in electrical contact with each other. Although the protrusions act as FCB mounting elements in the above embodiments, it will be understood that alternative arrangements of locating the terminations of FCBs, and the terminations of an FCB to a PCB, in direct contact with each other are envisaged. The mounting elements are arranged to locate the terminations of one FCB in direct contact with the terminations of another FCB or PCB. Each contacting mounting element urges the terminations of one FCB against the terminations of another FCB or PCB to ensure that there is a good electrical contact between the respective terminations of each FCB, or between a FBC and a PCB.

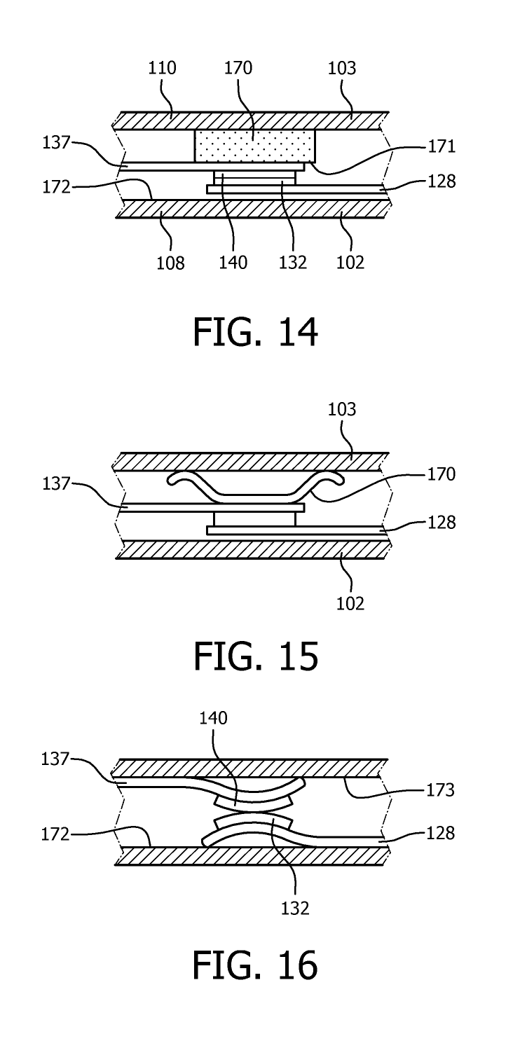

For example, another arrangement of a mounting arrangement is shown in FIG. 14. Reference numerals are retained from above-described embodiments for like elements. In this arrangement the indented protrusions are omitted. The outer shell 101 further comprises a resilient member 170 which is fixedly mounted to the top panel 110 of the upper housing. The resilient member 170 may be a rubber or a foam block. The resilient member 170 acts as a mounting element. The resilient member 170 is disposed midway along the FCB receiving area 115. The resilient member 170 has a mounting surface 171. The mounting surface 171 is configured to extend parallel to, but spaced from the base 108 of the lower housing 102 when the outer shell 101 is assembled. An inner surface 172 of the base 108 of the lower housing 102 acts as an opposing mounting surface. Therefore, the base 108 of the lower housing 102 defines the lower mounting element.

The mounting surface 171 is spaced from the inner surface 172 of the base 108 by a predetermined distance when the outer shell 101 is assembled and the surfaces are configured to be drawn away from each other when the lower and upper housings 102, 103 are separated.

During assembly, the first FCB 128 is received in the FCB receiving space 115. The first FCB 128 is guided into its correct position by positioning elements, as described above. The terminations 132 of the first FCB 128 are received midway along the FCB receiving space 115.

A rear side of the head portion of the first FCB 128 locates against the base panel 108, acting as a mounting element. The terminations 132 of the first FCB 128 face away from the base 108 on the other side of the first FCB 128. The second FCB 137 is then received in the FCB receiving space 115 and is guided into its correct position by positioning elements, as described above. The terminations 140 of the second FCB 137 are received midway along the FCB receiving space 115 and overlap the terminations 132 of the first FCB 128.

The upper housing 103 is then brought together with the lower housing 102. As the upper and lower housings 103, 104 are brought together, the resilient member 170 is guided towards the base panel 108 of the lower housing 102. The resilient member 170 protrudes into the cavity 107. The terminations 132, 140 of the first and second FCBs 128, 137 are received between the resilient member 170 and the base 108 forming opposing lower and upper mounting elements. The lower housing 102 mounts with the upper housing 103 so that the lower and upper housings 102, 103 are in engagement with each other. As the two housings 102, 103 are moved into engagement with each other the resilient member 170 abuts the rear side of the second FCB 137.

It will be understood that the distance between the mounting surface 171 of the resilient member 170 and the inner surface 172 of the base 108 is configured to be less than the combined thickness of the first and second FCBs 128, 137 at their terminations 132, 140. When the outer shell 101 is assembled, the resilient member 170 is compressed and exerts a compressive force on the first and second FCBs 128, 137. Therefore, the terminations 132, 140 of the two FCBs 128, 137 are urged against each other and are retained in position with respect to each other. The opposing terminations 132, 140 are put under a slight and evenly distributed compression against each other. This ensures that a good electrical contact is obtained between the terminations 132, 140.

In an alternative embodiment, the resilient member is mounted to the base of the lower housing. Furthermore, although in the above described embodiment a single resilient member is used which is mounted to the top cover to act as a mounting element and the base acts as another mounting element to act on the first FCB, it will be understood that a second resilient member may be mounted to the base of the lower housing to act as a mounting element, or alternatively the resilient member may be used together with another mounting element on the opposing housing, for example a protrusion as described above. In an alternative arrangement, as shown in FIG. 15, the resilient member 170 is a spring element.

In another alternative arrangement, as shown in FIG. 16, inner surfaces 172 and 173 of the base 108 of the lower housing 102 and top panel 110 of the upper housing 103 form lower and upper mounting surfaces respectively. In FIG. 16, the upper and lower housings 102, 103 are not in full engagement with each other. Therefore, it will be understood that the base 108 and top panel 110 define the mounting elements. In such an arrangement, the elasticity of the substrate of one or each of the FCBs may be used to ensure that the terminations 132, 140 of each of the FCBs 128, 137 are put under a slight and evenly distributed compression against each other. This ensures that a good electrical contact is obtained between the terminations 132, 140.

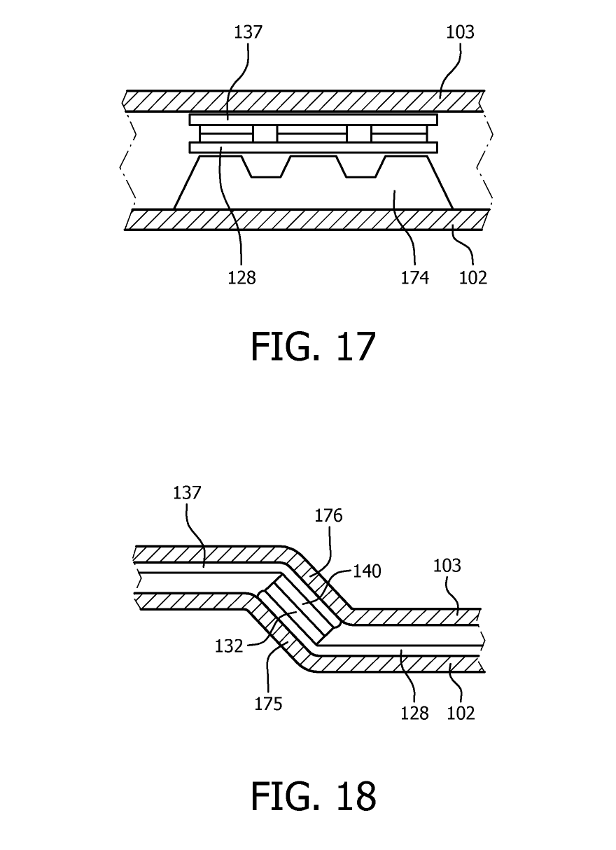

In an alternative arrangement, as shown in FIG. 17, a mounting element 174 has ridges 175 formed in it. This allows the compressive force to be exerted in specified positions on the FCBs. In particular, the ridges 175 may align with the terminations so that the compressive force is exerted on each termination independently . . . .

A further embodiment is shown in FIG. 18. In this embodiment the mounting elements have inclined surfaces 175, 176 which extend at an angle to the plane of each of the FCBs 128, 137 when the FCBs are received in the cavity 107 prior to assembly of the lower and upper housings 102, 103. The inclined surfaces 175, 176 extend at an inclined angle to the direction of attachment of the first and second housings when the outer shell 101 is assembled. The FCBs may be wedge shaped.

When the outer shell 101 is assembled the terminations 132, 140 of the FCBs slide along each other due to the inclined shape of the mounting elements. This enables any oxidation of the surface of the terminations 132, 140 to be removed by friction as the FCBs slide along each other. Furthermore, the integral elasticity of the FCBs, a section of which is urged to extend at an angle, urges the terminations 132, 140 of the FCBs towards each other.

An advantage of the above arrangements is that a production step is removed by eliminating the need to introduce a fixative such as an adhesive or solder between the FCBs, or an intermediate connector. Another advantage is that the above arrangements do not necessitate a conductive bridge between the terminations, for example electrically conductive adhesive, soldering tin, metal sockets/pins and any other type of connector. On the contrary, with the present arrangement the terminations are disposed in direct contact with each other which maximizes the electrical conductivity between the terminations.

One advantage of the above arrangements is that they are gender neutral and do not require separate male and female arrangements. Therefore, the housings, or separate modularly arranged housings may be interchangeable.

It will be appreciated that each of the mounting arrangements described in the above embodiments may be used in conjunction with any of the positioning means described above.

Although in the above embodiments the first and second FCBs are mounted to and electrically connected with a corresponding first and second PCB, it will be understood that alternative arrangements are envisaged. For example, one or more of the FCBs may be mounted to and extend from an alternative electrical component, or may be mounted to and extend from another FCB. In the above embodiments each FCB is shown and described to be mounted to and electrically connected with a corresponding PCB for ease of illustrative purposes only.

Although in the above embodiments the first and second FCBs are shown being mounted to and electrically connected with the first and second PCBs respectively using conventional connectors, it will be understood that the arrangement is used for ease of illustrative purposes only, and that the first and second FCBs may be arranged to be located against and electrically mounted to the first and second PCBs respectively using the system and method described in detail above.

Although in the above described embodiments the terminations of a FCB are arranged to be located against and be retained in contact with the terminations of another FCB, it will be understood that the above system and method may be used to locate and retain in contact the terminations of a FCB with the terminations of a PCB. Alternatively, embodiments of the system may be used to locate and retain in contact the terminations of a PCB with the terminations of another PCB.

It will be appreciated that the term “comprising” does not exclude other elements or steps and that the indefinite article “a” or “an” does not exclude a plurality. A single processor may fulfill the functions of several items recited in the claims. The mere fact that certain measures are recited in mutually different dependent claims does not indicate that a combination of these measures cannot be used to an advantage. Any reference signs in the claims should not be construed as limiting the scope of the claims.

Although claims have been formulated in this application to particular combinations of features, it should be understood that the scope of the disclosure of the present invention also includes any novel features or any novel combinations of features disclosed herein either explicitly or implicitly or any generalization thereof, whether or not it relates to the same invention as presently claimed in any claim and whether or not it mitigates any or all of the same technical problems as does the parent invention. The applicants hereby give notice that new claims may be formulated to such features and/or combinations of features during the prosecution of the present application or of any further application derived there from.

1. A system of lighting modules of which, a first lighting module comprises a housing, a light source and an electrical connector electrically coupled to the light source, wherein the housing of each lighting module is configured to be coupled to one or more of the other lighting modules so that the lighting modules are electrically connected to each other and wherein the housing comprises a mounting unit which simultaneously is to at least partly accommodate and at least partly to be received by a corresponding mounting unit of a second lighting module to couple to said second lighting module so that terminations of the electrical connector of the first lighting module are brought into direct contact with terminations of an electrical connector of the second lighting module to establish an electrical connection between the first and second lighting modules, each of the at least one mounting unit being of the same configuration and comprises an aperture which is bordered by at least a protrusion of the mounting unit.

2. A system of lighting modules according to claim 1, characterized in that the aperture is bordered by three walls formed by:
a resilient flap;
the protrusion oppositely arranged to the flap;
a base surface of a base panel extending from the flap towards the protrusion.

3. A system of lighting modules according to claim 2, characterized in that the resilient flap comprises a free edge which is configured to engage with an opposing ridge on the housing of the second lighting module.

4. A system of lighting modules according to claim 2, characterized in that the terminations are part of at least one of the three walls.

5. A system of lighting modules according to claim 1, wherein the electrical connector is a first electrical connector and the first lighting module further comprises a second electrical connector, the housing being configured to be coupled to a housing of a third lighting module so that terminations of the second electrical connector are brought into direct contact with terminations of an electrical connector of the third lighting module to establish an electrical connection between the first and third lighting modules.

6. A system of lighting modules according to claim 5, further comprising a circuit board disposed in the housing, wherein the first and second electrical connectors are coupled to the circuit board and extend from the circuit board.

7. A system of lighting modules according to claim 1, wherein the electrical connector is received in the housing and the housing is configured to locate the terminations of the electrical connector in direct contact with the terminations of the electrical connector of the second lighting module.

8. A system of lighting modules according to claim 1, wherein the housing is releasably attachable to the housing of the second lighting module so that the second lighting module is interchangeable with another lighting module.

9. A system of lighting modules according to claim 1, wherein the mounting unit is configured to bias the terminations of the electrical connector against the terminations of an electrical connector of the second lighting module.

10. A system of lighting modules according to claim 1, wherein a surface of the mounting unit which is configured to locate against the electrical connector is configured to be spaced from a surface of a mounting element of the housing of the second lighting module by a distance equal to or less than the combined thickness of the electrical connectors of the first and second lighting modules when the housing is coupled to the housing of the second lighting module.

11. A system of lighting modules according to claim 1, wherein the plane of the surface of the mounting unit is configured to extend at an angle to the direction of attachment of the housing of the first lighting module to the housing of the second lighting module.

12. A system of lighting modules according to claim 1, further comprising a positioning element configured to position the electrical connector in the housing.

13. A system of lighting modules according to claim 1, wherein the electrical connector is flexible.

14. A system of lighting modules according to claim 1, wherein the electrical connector is a flexible circuit board.

15. A lighting module suitable for use in a system of lighting modules according to claim 1, the lighting module comprising a housing, a light source and an electrical connector electrically coupled to the light source, wherein the housing comprises at least one mounting unit which simultaneously is to at least partly accommodate and at least partly to be received by a corresponding mounting unit of a second lighting module to be coupled to said second lighting module, each of the at least one mounting unit being of the same configuration and comprises an aperture which is bordered by at least a protrusion of the mounting unit, and wherein termination sections of terminations are exposed in the aperture.

16. (canceled)
